(19) United States
(12) Patent Application Publication
(10) Pub. No.: US 2024/0352050 A1
(43) Pub. Date: Oct. 24, 2024

(54) PROCESS FOR MAKING CYANOETHYLTRIMETHOXYSILANE

(71) Applicant: DOW SILICONES CORPORATION, Midland, MI (US)

(72) Inventors: Michael Depierro, Midland, MI (US); Kitty Liu, Midland, MI (US); Xiaoyuan Zhou, Midland, MI (US); Reza Panah, Midland, MI (US); Aaron Greiner, Midland, MI (US)

(21) Appl. No.: 18/684,217

(22) PCT Filed: Nov. 11, 2022
(86) PCT No.: PCT/US22/79675

§ 371 Date: Feb. 16, 2024

Related U.S. Application Data
(60) Provisional application No. 63/285,546, filed on Dec. 3, 2021.

(51) Int. Cl. C07F 7/18; C08K 5/5475; C09J 183/04

(52) U.S. Cl. CPC C07F 7/188; C09J 183/04; C08K 5/5475

(57) ABSTRACT

A process for preparing cyanoethyltrimethoxysilane is performed via transesterification of cyanoethyltriethoxysilane with methanol in the presence of a catalyst. The cyanoethyltrimethoxysilane is useful as an adhesion promoter, a coupling agent, or a crosslinker. The cyanoethyltrimethoxysilane may be formulated in a polyorganosiloxane sealant composition.

### CROSS REFERENCE TO RELATED APPLICATIONS

This application claims the benefit of U.S. Provisional Patent Application Ser. No. 63/285,546 filed on 3 Dec. 2021 under 35 U.S.C. § 119 (e). U.S. Provisional Patent Application Ser. No. 63/285,546 is hereby incorporated by reference.

### FIELD

This invention pertains to a process for making cyanoethyltrimethoxysilane. More particularly, this invention pertains to a process for making cyanoethyltrimethoxysilane via transesterification of cyanoethyltriethoxysilane.

### INTRODUCTION

Cyanoethyltrimethoxysilane (CETMS) is useful as an adhesion promoter or a coupling agent in siloxane compositions, such as room temperature vulcanizable (RTV) polyorganosiloxane sealant compositions. CETMS can be made via hydrosilylation reaction of acrylonitrile with trichlorosilane followed by methoxylation. CETMS can also be made by the hydrosilylation reaction of trimethoxysilane with acrylonitrile. However, these processes suffer from drawbacks with the result that CETMS is not widely available on a commercial scale.

### SUMMARY

A process for making cyanoethyltrimethoxysilane comprises combining cyanoethyltriethoxysilane, methanol, and an acid catalyst.

### DETAILED DESCRIPTION

More specifically, the process for making CETMS comprises:
1) combining starting materials comprising (A) the cyanoethyltriethoxysilane (CETES), (B) the methanol, in a stoichiometric excess, and (C) the acid catalyst; thereby producing a transesterification reaction mixture;
optionally 2) adding (D) activated carbon to the transesterification reaction mixture;
3) removing materials comprising methanol, ethanol and (C) the acid catalyst from the transesterification reaction mixture; and
4) repeating steps 1) to 3) one or more times (for a total of at least two additions of methanol and (C) acid catalyst and subsequent removal of methanol, ethanol, and catalyst).

In the process for making cyanoethyltrimethoxysilane, transesterification reaction of CETES and methanol may proceed according to the transesterification reaction scheme shown below.

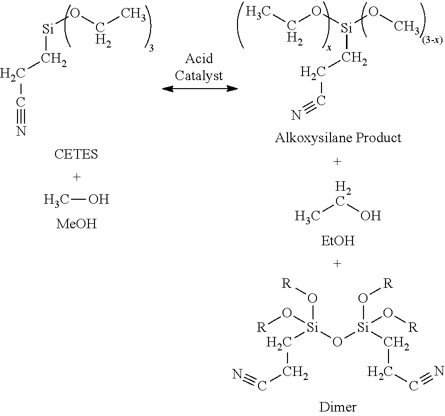

In the formula for the Alkoxysilane Product, when x=0 the formula is CETMS. However, partially methoxylated species, e.g., cyanoethyl-, diethoxy-, monomethoxy-silane (where x=2) and/or cyanoethyl-, monoethoxy-, dimethoxy-silane (where x=1), may also form during the process described herein. In the formula for the Dimer in this reaction scheme, each R is independently selected from the group consisting of methyl and ethyl. The Dimer is a side product that may form during the process described herein, and increasing formation of the Dimer negatively impacts yield of the CETMS. It is desirable to drive the reaction to a high conversion of the ethoxy groups in the CETES to methoxy groups, high purity of CETMS and low amount of Dimer formation.

In step 1) of the process described herein, (A) the cyanoethyltriethoxysilane and (B) the methanol are used in amounts sufficient to provide a stoichiometric excess of methanol. The amounts of (A) the cyanoethyltriethoxysilane and (B) the methanol may be at least 5:1 (B):(A) (molar ratio), alternatively at least 15:1, while at the same time (B):(A) may be up to 30:1, alternatively up to 15:1. Alternatively, (B):(A) may be 5:1 to 30:1, alternatively >5:1 to 30:1, and alternatively 15:1 to 30:1. Without wishing to be bound by theory, it is thought that Step 1) may be performed at RT or elevated temperature, such as up to 70° C. Alternatively, temperature may be 21° C. to 70° C. Time for the transesterification reaction in step 1) is sufficient to reach equilibrium. For example, at RT the time may be 1 hour to 4 hours. However, the exact time will depend on various factors such as the temperature selected and the selection and amount of (C) the acid catalyst. Without wishing to be bound by theory, it is thought that performing the transesterification reaction in step 1) at RT may be efficient in terms of time, energy, and cost associated with heating and cooling. The use of the acid catalyst may provide the benefit of enabling a fast reaction at RT, which minimizes time and operating cost. The reaction may be optionally carried out at elevated temperatures. Furthermore, step 1) may be performed under conditions that minimize or eliminate the presence of moisture. Without wishing to be bounded by theory, it is thought that moisture contamination may initiate a side reaction of Dimer formation that would take away from CETMS yield.

Starting material (C), the acid catalyst, may be selected from the group consisting of a hydrogen halide, e.g., of formula HX, where X is Cl, Br, or I; a sulfonic acid (such as toluene sulfonic acid or trifluoromethane sulfonic acid); and an ion exchange resin. Alternatively, (C) the acid catalyst may be the hydrogen halide, and alternatively the acid catalyst may be HCl. When (C) the acid catalyst is the hydrogen halide, e.g., HCl, the hydrogen halide (e.g., HCl) may be used in an amount of at least 1 ppm, alternatively at least 5 ppm, alternatively at least 10 ppm, alternatively at least 30 ppm, while at the same time the amount of hydrogen halide (e.g., HCl) may be up to 100 ppm, alternatively up to 50 ppm, alternatively up to 30 ppm, based on weight of (A) the CETES and weight of (B) the MeOH combined. Alternatively, the amount of hydrogen halide (e.g., HCl) may be 10 ppm to 100 ppm, alternatively 10 ppm to 50 ppm, and alternatively 30 ppm, on the same basis. Alternatively, when the ion exchange resin is used, the amount may be at least 0.1% of solid to liquid, alternatively at least 0.5% while at the same time the amount may be up to 30%, on the same basis. Alternatively, the amount of ion exchange resin may be 0.1% to 30%.

The starting materials used in the step 1) of the process are known in the art and are commercially available. CETES is available from Gelest Inc. of Morrisville, Pennsylvania, USA. MeOH and HCl are available from various sources including Sigma-Aldrich, Inc. of St. Louis, Missouri, USA. Ion exchange resins may be strong and weak acid cation exchange resins where the ionic form of the resin is not hydrogen (H+) for use herein. Such ion exchange resins are commercially available, for example, DOWEX™ Monosphere 2030, DOWEX™ MARATHON™ 1200 (Na+ form), and AMBERLITE IR122 Na are commercially available from TDCC.

Combining the starting materials in step 1) may be performed batchwise or continuously and by any convenient means, such as mixing. Mixing may be performed in conventional equipment, such as a batch reactor equipped with an agitator and optionally heating means, such as a jacket. Alternatively, the process may be performed in packed bed reactor, e.g., where the reactor may be packed with (C) the acid catalyst when a solid catalyst is used, e.g., the ion exchange resin, and/or when step 2) is present, e.g., activated carbon is used.

Step 2) of the process comprises combining (D) activated carbon and the transesterification reaction mixture prepared in step 1). Step 2) is optional. However, when used, step 2) may be performed at RT, for example, by mixing the activated carbon with the transesterification reaction mixture prepared in step 1) for a time sufficient to adsorb acid HCl therefrom. The exact time depends on various factors, such as size of the vessel used for step 2), (which may be the same as the reactor used in step 1),) however, the time may be at least 1 hour, alternatively at least 2 hours, alternatively at least 4 hours, alternatively at least 8 hours, and alternatively at least 16 hours; while concurrently the time may be up to 48 hours, alternatively up to 24 hours, and alternatively up to 16 hours. Step 2) may be performed under conditions that minimize or eliminate moisture.

When step 2) is present, (D) the activated carbon may be selected from the group consisting of (D1) bituminous coal activated carbon, (D2) coconut activated carbon with an iodine number≥1200 mg/g, and (D3) a combination of both (D1) and (D2). The (D1) bituminous coal activated carbon and (D2) coconut activated carbon are known in the art and are commercially available from various sources, such as General Carbon Corporation of Paterson, New Jersey, USA, or Calgon Carbon of Pittsburgh, Pennsylvania, USA. The bituminous coal activated carbon may have an iodine number of at least 500 mg/g (min), alternatively at least 600 mg/g (min), alternatively at least 750 mg/g (min), alternatively at least 850 mg/g (min), alternatively at least 900 mg/g (min), while at the same time the bituminous coal activated carbon may have an iodine number up to 1200 mg/g (min), alternatively up to 1,100 mg/g (min), alternatively up to 1,000 mg/g (min), and alternatively up to 950 mg/g (min). Alternatively, iodine number of the bituminous coal activated carbon may be 600 mg/g (min) to 1200 mg/g (min), alternatively 750 mg/g (min) to 1200 mg/g (min), 900 mg/g (min) to 1200 mg/g (min), and alternatively 900 mg/g (min) to 1050 mg/g (min). Iodine number of the coconut activated carbon may be ≥1200 mg/g (min), alternatively 1,200 mg/g (min) to 1,500 mg/g (min), and alternatively 1,200 mg/g (min) to 1,300 mg/g (min).

Examples of bituminous coal activated carbon include GC 12×40, which is a virgin activated carbon which is granular in form with an iodine number of 900 mg/g (min) and a density of 0.47 to 0.53 g/cc and which is commercially available from General Carbon Corporation; and CAL™ 12×40 granular activated carbon, which is reagglomerated metallurgical grade bituminous coal with an iodine number of 1000 mg/g (min), and which is commercially available from Calgon Carbon. Other bituminous coal activated carbons from Calgon Carbon include CPG™ LF 12×40, which has an iodine number of 950 mg/g (min); FILTRASORB™ 300M, which has an iodine number of 900 mg/g (min); FILTRASORB™ 400M, which has an iodine number of 1000 mg/g (min); HPC MAXX, which has an iodine number 900 mg/g; and SGL 8×20, which is a granular activated carbon made from bituminous coal combined with binders and having iodine number 900 (min) mg/g. Coconut activated carbons include OLC Plus 12×30, which has an iodine number of 1200 mg/g (min) and a density of 0.45 g/cc, and OLC Plus 12×30 is also available from Calgon Carbon.

When step 2) is present (i.e., the activated carbon is used), the process may further comprise treating the activated carbon before use in step 2). Treating may be performed, e.g., to dry the activated carbon (e.g., remove all or a portion of any adsorbed moisture to minimize potential for hydrolysis of the Alkoxysilane Product when the carbon contacts the transesterification reaction mixture). For example, the activated carbon may be heated to a temperature above the boiling point of water (e.g., >100° C., alternatively >100° C. to 200° C., alternatively 120° C. to 160° C.) for a time sufficient to remove all or a portion of the water, e.g., 1 minute to 24 hours. The activated carbon may be heated at ambient or reduced pressure. The activated carbon may be heated and stored under an inert atmosphere, such as nitrogen, before use in step 2).

Step 3) of the process comprises removing materials comprising (excess) unreacted (B) methanol, ethanol (which is produced as a side product), and (C) the acid catalyst from the transesterification reaction mixture. Step 3) may be performed by any convenient means. Step 3) may comprise filtration, e.g., to remove solid materials, such as ion exchange resin, when used as (C) the acid catalyst, and/or activated carbon, when step 2) is present. Step 3) may also comprise stripping and/or distillation with heating and optionally with reduced pressure, which can remove methanol, ethanol, and liquid acid catalysts, such as HCl.

Step 4) of the process comprises repeating steps 1) to 3) one or more times. Step 4) may comprise repeating 1) to 3) at least one time, alternatively one to four times. Without wishing to be bound by theory, it is thought that repeating steps 1) to 3) too many times (e.g., five or more times (alternatively 5 or more times), for a total of six to seven, or more, additions of methanol and acid catalyst and subsequent removals, may result in undesirably high amounts of the Dimer being formed and/or increased costs that make the process impractical on a commercial scale. Alternatively, step 4) may comprise repeating steps 1) to 3) one or two times, particularly when step 2) is present. Without wishing to be bound by theory, it is thought that due to thermodynamic equilibrium limitations and higher volatility of methanol than ethanol, during step 3), (e.g., via stripping and/or distillation) a reverse reaction can occur via reaction of the CETMS (where x=0 in the formula for the Alkoxylated Product shown above) or partially the methoxylated species (where x=1 or 2) with the EtOH side product, which cannot be removed until all or a significant portion of the lower boiling point MeOH is first removed. Furthermore, the inventors surprisingly found that treating the transesterification reaction mixture with activated carbon in step 2) minimized this reverse reaction. Because each repetition of steps 1) to 3) can add cost to the process, it is desirable to minimize the number of repetitions in step 4) for efficiency, provided yield and purity of the CETMS product is achieved.

The process described above may optionally further comprise one or more additional steps. For example, after step 4), process may further comprise: 5) treating the CETMS with activated carbon. Without wishing to be bound by theory, step 5) may be performed by pumping the CETMS through a vessel, such as a drum or bed, that contains activated carbon, or the activated carbon may be added to the vessel used in step 4) and thereafter filtered out of the product. The activated carbon used in step 5) may be the as described above with respect to step 2). When step 2) and/or step 5) is present, the process may optionally further comprise drying the activated carbon before use.

The process described above produces a composition comprising cyanoethyltrimethoxysilane (CETMS), which has formula:

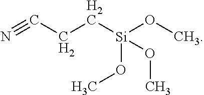

Conversion of the ethoxy groups of the CETES starting material to methoxy groups may be at least 90 GC area %, alternatively at least 91 GC area %, alternatively at least 92 GC area %, alternatively at least 93 GC area %, and alternatively at least 94 GC area %, while at the same time, the conversion may be up to 100 GC area %, alternatively up to 99 GC area %, alternatively up to 98 GC area %, alternatively up to 97 GC area %, and alternatively up to 96 GC area %, as measured by the test method described below and used in the examples. Purity of the CETMS may be at least 72 GC area %, alternatively at least 81 GC area %, alternatively at least 86 GC area %, alternatively at least 89 GC area %, and alternatively at least 90 GC area %, while at the same time purity of the CETMS may be up to 100 GC area %, alternatively up to 98 GC area %, alternatively up to 95 GC area %, alternatively up to 92 GC area %, and alternatively up to 90 GC area %, as measured by the test method described below and used in the examples. The amount of Dimer may be 0, alternatively 1 wt % to 10 wt %, alternatively 1.5 wt % to 9 wt %, alternatively 1.8 wt % to 6 wt %, alternatively 2 wt % to 3 wt %. However, amount of Dimer may vary depending on whether step 2) is present. For example, amount of dimer may be 1 wt % to 3 wt %, alternatively 1.5 wt % to 2 wt %, and alternatively 1.8 wt % when step 2) of the process is omitted (no treating agent is used). When the treating agent (e.g., activated carbon) is used, then amount of dimer may be 5 wt % to 10 wt %, alternatively 6 wt % to 9 wt %.

The composition comprising CETMS produced as described above may be used in a polyorganosiloxane composition, such as a room temperature vulcanizable organopolysiloxane composition. RTV organopolysiloxane compositions are known in the art, such as those disclosed in U.S. Pat. No. 4,483,973 to Lucas, et al.; U.S. Pat. No. 5,962,559 to Lucas, et al.; U.S. Pat. No. 7,550,548 to Hatanaka, et al.; U.S. Pat. No. 7,674,871 to Koch, et al.; U.S. Patent Application Publication 2007/0173597 to Williams, et al.; and PCT Patent Application Publication WO2007/024792. The CETMS may function as an adhesion promoter, a coupling agent, and/or a crosslinking agent in a polyorganosiloxane composition. Alternatively, the CETMS may be added to a commercially available RTV sealant, such as XIAMETER™ SLT-5200 from DSC.

### EXAMPLES

These examples are intended to illustrate the invention to one skilled in the art and are not to be construed so as to limit the invention set forth in the claims. Materials used herein are described in Table 1.

TABLE 1

| Material | Description | Source |
|---|---|---|
| CETES | Cyanoethyltriethoxysilane | Gelest, Inc. |
| CETMS | Cyanoethyltrimethoxysilane | Synthesized in the |
| | | examples |
| MeOH | methanol | Sigma Aldrich |
| HCl | Hydrochloric acid | Sigma Aldrich |
| NaOMe | Sodium methylate | Sigma Aldrich |
| NaHCO₃ | Sodium bicarbonate | Sigma Aldrich |
| CAL ™ 12 × 40 | Granular activated, carbon which is | Calgon Carbon |
| carbon | reagglomerated metallurgical grade | |
| | bituminous coal with an iodine number of | |
| | 1000 mg/g (min) | |
| OLC Plus 12 × 30 | Coconut activated carbon with an iodine | Calgon Carbon |
| carbon | number of 1200 mg/g (min) and a density | |
| | of 0.45 g/cc | |
| Dowex | Sulfonic acid functionality Ion Exchange | Sigma Aldrich |
| Monosphere 2030 | Resin | |
| Tyzor ™ Pita SM | An organometallic catalyst that is a | ChemPoint |
| (Ti-based) | mixture of Titanium Ethyl Acetoacetate | |
| | and Methyl-trimethoxy Silane | |
| Ti (IV) Butoxide | Titanium(IV) butoxide | Sigma Aldrich |
| FILTRASORB ™ | Granular activated carbon, which is | Calgon Carbon |
| 400 | reagglomerated bituminous coal with | |
| | iodine number 1000 mg/g (min) and | |
| | density of 0.54 g/cc | |
| CPG ™-LF 12 × 40 | Acid washed granular activated carbon | Calgon Carbon |
| | made from bituminous coal combined | |
| | with binders. | |
| OLC AW 12 × 40 | Acid washed coconut activated carbon | Calgon Carbon |
| | with iodine number 1050 min mg/g | |
| Darco | Lignite coal activated carbon | Cabot |
| SGL | Bituminous coal activated carbon with | Calgon Carbon |
| | iodine number 900 mg/g | |
| HPC MAXX | Bituminous coal activated carbon with | Calgon Carbon |
| | iodine number 900 mg/g | |
| ACTICARBONE ™ | Wood based activated carbon | Calgon Carbon |
| BGX | | |
| Cl-850 | Activated alumina | BASF |
| Cl-750 | Activated alumina | BASF |
| OLC1100 | Coconut activated carbon with iodine | Calgon Carbon |
| | number 1100 mg/g | |
| OLC 12 × 40 | Coconut activated carbon with iodine | Calgon Carbon |
| | number 1050 mg/g | |

In this Reference Example, samples of activated carbon were treated before use, as follows: each sample of activated carbon was dried in a vacuum oven at 140° C. overnight prior to use. The carbon was then stored in a N2 purged glovebox to prevent water being adsorbed from the air. Without wishing to be bound by theory, it is thought that the level of moisture in the carbon can impact kinetics and possibly increase Dimer levels when performing the process described herein.

In this Example 1, 172 g of MeOH was added to 234 g of CETES in a 1 L round bottle flask under stir-bar agitation. Then, 115 uL of 3M HCl in MeOH was added to the flask. Transesterification reaction was completed after 1 hour at room temperature. The reaction mixture was then distilled to remove MeOH and EtOH under 75-150 mmHg vacuum at 30-50° C. prior to addition of new MeOH and catalyst. This process of distillation and new MeOH addition was continued four more times (totaling 5 MeOH additions) before reaching 81% purity of CETMS.

In this Example 2a, 273 g of MeOH was added to 173 g of CETES in a 1 L flask under stir-bar agitation. Then, 115 uL of 3M HCl in MeOH was added to the flask and reaction was completed after 1 hour at RT. The reaction mixture was then distilled to remove MeOH and EtOH under 75-150 mmHg vacuum at 30-50° C. prior to addition of new MeOH and catalyst. This process of new MeOH addition and distillation was repeated two more times before reaching 72% purity of CETMS. The flask contents were analyzed after each distillation.

In this Example 2b, Example 2a was continued with another MeOH addition (totaling 4 MeOH additions). After the same reaction and distillation conditions, the material reached 90% purity of CETMS.

In this Example 2c, Example 2b was continued with another MeOH addition (totaling 5 MeOH additions). After the same reaction and distillation conditions, the material reached 95% purity of CETMS.

In this Example 3, 336 g of MeOH was added to 76 g of CETES in a 1 L flask under stir-bar agitation. Then, 115 uL of 3M HCl was added to the flask, and the reaction was completed after 1 hour at room temperature. The reaction mixture was then distilled to remove MeOH and EtOH under 75-150 mmHg vacuum at 30-50° C. prior to addition of more MeOH and catalyst. This process of new MeOH addition and distillation was repeated three more times before reaching 94% purity of CETMS. The flask contents were analyzed after each distillation.

In this Example 4a, 273 g of MeOH was added to 173 g of CETES in a 1 L flask under stir-bar agitation. Then, 0.11 g of 25 wt % NaOMe was added to the reactor, and the reaction was completed after 1 hour at room temperature. The reaction mixture was then distilled to remove MeOH and EtOH under 75-150 mmHg vacuum at 30-50° C. prior to addition of more MeOH and NaOMe as catalyst. This process of MeOH addition and distillation was repeated two more times before reaching 79% purity of CETMS. The flask contents were analyzed after each distillation.

In this Example 4b, Example 4a was continued with another MeOH addition (totaling 4 MeOH additions). After the same reaction and distillation conditions, the material reached 90% purity of CETMS.

In this Example 5, 273 g of MeOH was added to 173 g of CETES in a 1 L flask under stir-bar agitation. Then, 115 uL of 3M HCl in MeOH was added to the flask, and the reaction was completed after 1 hour at room temperature. Molar equivalent of NaOMe was added to the reaction mixture and stirred for 1 hour to neutralize HCl. Neutralized salt was removed from the reaction mixture using a 6 um filter paper and Buchner funnel. The filtered material was then distilled to remove EtOH and MeOH under 75-150 mmHg vacuum at 30-50° C. prior to addition of more MeOH and HCl as catalyst. The process of new MeOH/HCl catalyst addition, neutralization, filtration, and distillation was continued two more times before reaching 49% purity of CETMS. The flask contents were analyzed after each distillation.

In this Example 6, 273 g of MeOH was added to 173 g of CETES in a 1 L flask under stir-bar agitation. Then, 115 uL of 3M HCl in MeOH was added to the flask, and the reaction was completed after 1 hour at room temperature. Then, 0.15 g of NaHCO₃ was added to the reaction mixture and stirred for 1 hour to neutralize HCl. Salts were removed from the reaction mixture using a 6 um filter paper and Buchner funnel. The filtered material was then distilled to remove EtOH and MeOH under 75-150 mmHg vacuum at 30-50° C. prior to addition of more MeOH and catalyst. The process of NaHCO₃ addition, filtration, distillation, and new MeOH/catalyst addition was continued two more times before reaching 53% purity of CETMS. The flask contents were analyzed after each distillation.

In this Example 7, 273 g of MeOH was added to 173 g of CETES in a 1 L flask under stir-bar agitation. Then, 115 uL of 3M HCl in MeOH was added to the reactor, and the reaction was completed after 1 hour at room temperature. 20 g of Cal 12×40 carbon was added to the reaction mixture and stirred overnight. Carbon was removed from the reaction mixture using a 0.45 um cellulose-based Nalgene disposable filter. The filtered material was then distilled to remove EtOH and MeOH under 75-150 mmHg vacuum at 30-50° C. prior to addition of more MeOH and catalyst. The process of carbon addition, filtration, distillation, and new MeOH/catalyst addition was continued two more times before reaching 89% purity of CETMS. The flask contents were analyzed after each distillation.

In this Example 8a, 273 g of MeOH was added to 173 g of CETES in a 1 L flask under stir-bar agitation. Then, 115 uL of 3M HCl in MeOH was added to the reactor, and the reaction was completed after 1 hour at room temperature. 20 g of OLC Plus 12×30 carbon was added to the reaction mixture and stirred overnight. Carbon was removed from the reaction mixture using a 0.45 um cellulose-based Nalgene disposable filter. The filtered material was then distilled to remove EtOH and MeOH under 75-150 mmHg vacuum at 30-50° C. prior to addition of more MeOH and catalyst. The process of carbon addition, filtration, distillation, and new MeOH/catalyst addition was continued one more time before reaching 86% purity of CETMS.

In this Example 8b, the process of carbon addition, filtration, distillation, and new MeOH/catalyst addition in Example 8a was continued one more time after this (for a total of 3 times), resulting in 92% purity of CETMS.

TABLE 2
Results of Examples 1-8 above

| | Treating | MeOH:CETES | | | | Methoxy | # of |
|---|---|---|---|---|---|---|---|
| | Agent (if | Molar | | Purity of | Dimer | Group | MeOH |
| Example | any) | Ratio | Catalyst | CETMS | wt % | Conversion | additions |
| 1 | None | 5:1 | HCl | 32% | 1% | 72% | 2 |
| 1 | None | 5:1 | HCl | 81% | 3% | 94% | 5 |
| 2a | None | 15:1 | HCl | 56% | 1.5% | 84% | 2 |
| 2a | None | 15:1 | HCl | 72% | 1.8% | 90% | 3 |
| 2b | None | 15:1 | HCl | 90% | 1.8% | 97% | 4 |
| 2c | None | 15:1 | HCl | 95% | 1.8% | 99.3% | 5 |
| 3 | None | 30:1 | HCl | 72% | 2% | 91% | 2 |
| 3 | None | 30:1 | HCl | 95% | 3% | 99.4% | 4 |
| 4a | None | 15:1 | NaOMe | 56% | 2.8% | 84% | 2 |
| 4a | None | 15:1 | NaOMe | 79% | 3% | 93% | 3 |
| 4b | None | 15:1 | NaOMe | 91% | 3% | 97% | 4 |
| 5 | NaOMe | 15:1 | HCl | 62% | 11% | 89% | 2 |
| 5 | NaOMe | 15:1 | HCl | 49% | 47% | 98.4% | 3 |
| 6 | NaHCO₃ | 15:1 | HCl | 52% | 2.6% | 83% | 2 |
| 6 | NaHCO₃ | 15:1 | HCl | 53% | 34% | 93% | 3 |
| 7 | Cal 12 × 40 | 15:1 | HCl | 84% | 6% | 97% | 2 |
| | Carbon | | | | | | |
| 7 | Cal 12 × 40 | 15:1 | HCl | 89% | 9% | 99.9% | 3 |
| | Carbon | | | | | | |
| 8a | OLC Plus | 15:1 | HCl | 86% | 6% | 96% | 2 |
| | 12 × 30 | | | | | | |
| 8b | OLC Plus | 15:1 | HCl | 92% | 6% | 99.4% | 3 |
| | 12 × 30 | | | | | | |

In this Example 9, 172 g of MeOH was added to 234 g of CETES in a 1 L under stir-bar agitation. Then, 115 uL of 3M HCl was added to the flask, and reaction was completed after 1 hour at RT. The reaction mixture was then distilled to remove MeOH and EtOH under 75-150 mmHg vacuum at 30-50° C. After distillation the material reached 10% purity of CETMS.

In this Example 10, 273 g of MeOH was added to 173 g of CETES in a 1 L flask under stir-bar agitation. Then, 115 uL of 3M HCl was added to the flask and reaction was completed after 1 hour at RT. The reaction mixture was then distilled to remove MeOH and EtOH under 75-150 mmHg vacuum at 30-50° C. After distillation the material reached 23% purity of CETMS.

In this Example 11, 273 g of MeOH was added to 173 g of CETES in a 1 L flask under stir-bar agitation. Then, 0.11 g of 25 wt % NaOMe was added to the flask and reaction was completed after 1 hour at RT. The reaction mixture was then distilled to remove MeOH and EtOH under 75-150 mmHg vacuum at 30-50° C. After distillation the material reached 21% purity of CETMS.

In this Example 12, 273 g of MeOH was added to 173 g of CETES in a 1 L flask under stir-bar agitation. Then, 2 g of Dowex Monosphere 2030 (Dowex) was added to the flask, and the reaction was completed after 1 hour at RT. The Dowex was removed from the reaction mixture using a 6 um filter paper and a Buchner funnel. The filtered material was then distilled to remove EtOH and MeOH under 75-150 mmHg vacuum at 30-50° C. After distillation the material reached 20% purity of CETMS.

In this Example 13, 172 g of MeOH was added to 234 g of CETES in a 1 L flask under stir-bar agitation. Then, 0.35 g of Tyzor Pita SM was added to the flask, and the reaction was completed after 8-hour at RT. The material was then distilled to remove EtOH and MeOH under 75-150 mmHg vacuum at 30-50° C. After distillation the material reached 9% purity of CETMS.

In this Example 14, 172 g of MeOH was added to 234 g of CETES in a 1 L flask under stir-bar agitation. Then, 0.4 g of Ti (IV) Butoxide was added to the flask, and the reaction was completed after 10 hours at RT. The material was then distilled to remove EtOH and MeOH under 75-150 mmHg vacuum at 30-50° C. After distillation the material reached 9% purity of CETMS.

Results of the catalyst screening in Examples 9-14 are shown below in Table 3. HCl and ion exchange resin showed the highest purity of CETMS and lowest dimer formation under the conditions tested.

TABLE 3
Catalyst screening after 1 pass of MeOH addition and distillation

| | | | | MeOH:CETES | | | | | Methoxy |
|---|---|---|---|---|---|---|---|---|---|
| | | Catalyst | | Molar | Reaction | | Purity of | Dimer | Group |
| Example | Catalyst | conc. | | Ratio | time | | CETMS | wt % | Conversion |
| 9 | HCl | 30 | ppm | 5:1 | 1 | hour | 10% | 0.59 | 56% |
| 10 | HCl | 30 | ppm | 15:1 | 1 | hour | 23% | 1.3 | 66% |
| 11 | NaOMe | 75 | ppm | 15:1 | 1 | hour | 21% | 2.4 | 65% |
| 12 | Dowex | 0.5 | wt % | 15:1 | 1 | hour | 20% | 1.1 | 64% |
| | Monosphere | | | | | | | | |
| | 2030 | | | | | | | | |
| 13 | Tyzor Pita | 1000 | ppm | 5:1 | 8 | hours | 9% | 1.5 | 55% |
| | SM (Ti- | | | | | | | | |
| | based) | | | | | | | | |
| 14 | Ti (IV) | 1000 | ppm | 5:1 | 10 | hours | 9% | 2.1 | 55% |
| | Butoxide | | | | | | | | |

In this Example 15, a stock solution of 520 g of MeOH and 235 g of CETES was added to a 2 L HDPE bottle. 50 g was then remove from the stock solution to retain a control sample. Then, 0.2 g of 3M HCl was added to the stock solution and mixed with a stir bar for 1 hour. Next, 50 g was aliquoted into thirteen 4 oz HDPE bottles and 2.5 g of each carbon or activated alumina indicated in Table 4 was added into their respective bottles. The materials were then placed on a wrist action shaker overnight. To remove carbon or alumina, a 0.45 um PTFE syringe filter was used. The filtered material was then titrated to determine chloride content.

TABLE 4

| | | Chloride |
|---|---|---|
| Carbon or | | Content |
| Alumina used | Type | (ppm) |
| None | | 38 |
| CAL ™ 12 × 40 | Bituminous coal Iodine number: 1000 | 5 |
| FILTRASORB ™ | Bituminous coal Iodine number: 1000 | 7 |
| 400 | | |
| CPG-LF | Bituminous coal Iodine number: 950 | 9 |
| SGl | Bituminous coal Iodine number: 900 | 8 |
| HPC MAXX | Bituminous coal Iodine number: 900 | 14 |
| OLC AW 12 × 40 | Coconut-based carbon Iodine number: | 112 |
| | 1050 Acid washed | |
| OLC Plus 12 × 30 | Coconut-based carbon Iodine number: | 6 |
| | 1200 | |
| OLC1100 | Coconut-based carbon Iodine number: | n/a basic |
| | 1100 | |
| OLC 12 × 40 | Coconut-based carbon Iodine number: | n/a basic |
| | 1050 | |
| Darco | Lignite coal | 54 |
| ACTICARBONE ™ | Wood-based carbon | 52 |
| BGX | | |
| Cl-850 | Activated Alumina | n/a basic |
| Cl-750 | Activated Alumina | n/a basic |

Without wishing to be bound by theory, it is thought that residual acid, such as HCl, in the transesterification reaction mixture prior to removal of volatiles, e.g., by stripping or distillation, promotes formation of CETES during removal of volatiles occurs due to Le Chatelier's principle of chemical equilibrium. Methanol is removed first, and as the transesterification reaction mixture contains ethanol and catalyst, the backwards reaction of forming CETES can occurs. By effectively adsorbing the residual acid, e.g., HCl, removing the catalyst also removes the ability to initiate the backwards reaction during stripping. Table 4 shows a list of carbon screenings to understand which adsorbents (activated carbons) were best at removing HCl, by looking at the residual Cl-content. Suitable activated carbons were those that reduced Cl-content to <38 ppm (the control) without creating a basic solution.

### Test Methods

Gas Chromatography (GC) was used to verify composition of material with internal standard composition of 1 wt % nonane in acetonitrile. All reported compositions are based on GC area % unless otherwise indicated. An Agilent 7890A GC System with helium carrier gas and an FID detector was used with Restek Rtx-1 30 m×0.25 mm×1 um. Flow rate was set at a constant flow of 1.5 mL/min. The gradient began at 40° C. for 2 min, then ramped at 20° C./min to 260° C. The final temperature of 260° C. was held for 2 min. Other conditions were:

1. Injection volume of 1 uL

2. Needle washing with acetonitrile for Solvent A and B Washes

3. Split/splitless inlet temperature and FID temperature of 260° C.

4. Split injection with a split ratio of 50:1

Titrations were performed with a Metrohm Brinkmann 776 Dosimat to determine chloride level with BCP indicator and 0.1N KOH.

### INDUSTRIAL APPLICABILITY

To achieve high conversion to CETMS via transesterification of CETES with MeOH, reaction and subsequent removal of EtOH and other materials can be repeated several times. Due to thermodynamic equilibrium limitations and higher volatility of MeOH than EtOH, during removal of EtOH, (e.g., via stripping and/or distillation) a reverse reaction can occur via reaction of the CETMS (where, in the reaction scheme above, x=0) or the partially methoxylated species (where x=1 or 2) with the EtOH by-product, which cannot be removed until the lower boiling point MeOH reactant is first removed.

The inventors found that activated carbon treatment dramatically reduced the number of repetitions required to achieve good conversion (e.g., as shown by high purity of CETMS) and selectivity (e.g., as shown by low amount of Dimer). This was particularly surprising because alternative neutralization methods (such as adding sodium methylate or sodium bicarbonate) did not produce the same reduction, as shown in the examples above.

The examples above showed that Ti-based catalysts catalyzed the transesterification reaction, however, the system took much longer (>8 hr) to reach equilibrium than when an acid or base catalyst was used (<1 hr) under the conditions tested (transesterification reactions performed at RT). Furthermore, the examples above showed that even though base catalysts provided the comparable reaction rates to the acid catalysts, base catalysts suffered from the drawbacks of promoting formation of more impurities (e.g., Dimers) than acid catalysts used under the same conditions. Without catalyst, the transesterification reaction did not occur, even at elevated temperature (>70° C.) under the conditions tested in the examples.

### DEFINITIONS AND USAGE OF TERMS

The amounts of all starting materials in a composition total 100% by weight. The Summary and the Abstract are hereby incorporated by reference. The articles ‘a’, ‘an’, and ‘the’ each refer to one or more, unless otherwise indicated by the context of specification. The singular includes the plural unless otherwise indicated. Each embodiment or alternative presented herein may be combined with any other embodiment or alternative. The term “comprising” and derivatives thereof, such as “comprise” and “comprises” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Abbreviations used in this application are defined below in Table 5.

TABLE 5
Abbreviations

| Abbreviation | Definition |
|---|---|
| AN | acid number |
| ° C. | degrees Celsius |
| cc | cubic centimeter |
| CETES | cyanoethyltriethoxysilane |
| CETMS | cyanoethyltrimethoxysilane |
| DSC | Dow Silicones Corporation of Midland, Michigan USA |
| EtOH | ethanol |
| g | gram |
| GC | gas chromatography |
| HDPE | High density polyethylene |
| hr | hour |
| L | liter |
| M | molar |
| MeOH | methanol |
| mg | milligram |
| mmHg | millimeters of mercury |
| N | normal |
| oz | ounce |
| RT | room temperature of 23 ± 2° C. |
| RTV | room temperature vulcanizable |
| TDCC | The Dow Chemical Company of Midland, Michigan, USA |
| uL | microliter |
| um | micrometer |
| wt | weight |

### Embodiments of the Invention

In a first embodiment, a process for preparing cyanoethyltrimethoxysilane comprises:
1) combining starting materials comprising
   (A) cyanoethyltriethoxysilane,
   (B) methanol, in a stoichiometric excess sufficient to provide a molar ratio of methanol:cyanoethyltrimethoxysilane, (B):(A) molar ratio, of at least 15:1, and
   (C) HCl in an amount of at least 30 ppm based on combined weights of (A) the cyanoethyltriethoxysilane and (B) the methanol; thereby producing a transesterification reaction mixture; and
2) adding to the transesterification reaction mixture (D) an activated carbon selected from the group consisting of
   (D1) bituminous coal activated carbon with an iodine number of at least 900 mg/g,
   (D2) coconut activated carbon with an iodine number of at least 1200 mg/g, and
   (D3) both (D1) and (D2);
3) removing materials comprising methanol, ethanol and the acid catalyst from the transesterification reaction mixture; and
4) repeating steps 1) to 3) one to four times.

In a second embodiment, in the process of the first embodiment, the (B):(A) molar ratio is 15:1 to 30:1.

In a third embodiment, in the process of the first embodiment or the second embodiment, where the HCl is used in an amount of 30 ppm to 100 ppm.

In a fourth embodiment, in the process of any one of the preceding embodiments, where step 1) is performed at 21° C. to 70° C.

In a fifth embodiment, in the process of any one of the preceding embodiments, where step 2) is performed at 21° C. to 70° C.

In a sixth embodiment, in the process of any one of the preceding embodiments, (D) the activated carbon is (D1) the bituminous coal activated carbon with an iodine number of 900 mg/g (min) to 1200 mg/g (min).

In a seventh embodiment, in the process of any one of the first to fifth embodiments,

(D) the activated carbon is (D2) the coconut activated carbon with an iodine number of 1200 mg/g (min) to 1300 mg/g (min).

In an eighth embodiment, the process of any one of the first to seventh embodiments, further comprises treating (D) the activated carbon before step 2).

In a ninth embodiment, in the process of the eighth embodiment, treating (D) the activated carbon comprises heating at a temperature of >100° C. to 200° C.

In a tenth embodiment in the process of any one of the preceding embodiments, step 4) is repeating steps 1) to 3) one or two times.

In an eleventh embodiment, a composition comprising cyanoethyltrimethoxysilane is prepared by the process of any one of the preceding embodiments.

In a twelfth embodiment, use of the composition of the eleventh embodiment in a polyorganosiloxane sealant composition is provided.

In a thirteenth embodiment, in the twelfth embodiment, the composition is an adhesion promoter, a coupling agent, or a crosslinker.

In a fourteenth embodiment, a process comprises adding the composition of the eleventh embodiment to a room temperature vulcanizing polyorganosiloxane sealant composition.

1. A process for preparing cyanoethyltrimethoxysilane, wherein the process comprises:
1) combining starting materials comprising
(A) cyanoethyltriethoxysilane,
(B) methanol, in a stoichiometric excess, and
(C) an acid catalyst; thereby producing a transesterification reaction mixture; and
optionally 2) adding to the transesterification reaction mixture (D) an activated carbon selected from the group consisting of
(D1) bituminous coal activated carbon,
(D2) coconut activated carbon with an iodine number of at least 1200 mg/g, and
(D3) both (D1) and (D2);
3) removing materials comprising methanol, ethanol and the acid catalyst from the transesterification reaction mixture; and
4) repeating steps 1) to 3) one or more times.

2. The process of claim 1, where in step 1), an amount of (A) the cyanoethyltriethoxysilane and an amount of (B) methanol is used in a molar ratio (B):(A) of at least 5:1, alternatively 5:1 to 30:1, alternatively >5:1 to 30:1, and alternatively 15:1 to 30:1.

3. The process of claim 1, where (C) the acid catalyst is selected from the group consisting of HCl and an ion exchange resin.

4. The process of claim 1, where (C) the acid catalyst is HCl, and the HCl is used in an amount of at least 30 ppm based on weight of (A) the cyanoethyltriethoxysilane and weight of (B) the methanol combined, and time for step 3) is 1 to 4 hours.

5. The process of claim 1, where step 2) is present.

6. The process of claim 5, where (D) the activated carbon is (D1) the bituminous coal activated carbon with an iodine number≥900 mg/g (min).

7. The process of claim 5, where (D) the activated carbon is (D2) the coconut activated carbon.

8. The process of claim 5, further comprising treating (D) the activated carbon before step 2).

9. The process of claim 5, where step 4) is repeating steps 1) to 3) one or two times.

10.-12. (canceled)

13. A method for preparing a polyorganosiloxane sealant composition, wherein the method comprises:
1) combining starting materials comprising
(A) cyanoethyltriethoxysilane,
(B) methanol, in a stoichiometric excess, and
(C) an acid catalyst; thereby producing a transesterification reaction mixture; and
optionally 2) adding to the transesterification reaction mixture (D) an activated carbon selected from the group consisting of
(D1) bituminous coal activated carbon,
(D2) coconut activated carbon with an iodine number of at least 1200 mg/g, and
(D3) both (D1) and (D2);
3) removing materials comprising methanol, ethanol and the acid catalyst from the transesterification reaction mixture; and
4) repeating steps 1) to 3) one or more times,
thereby preparing a composition comprising cyanoethyltriethoxysilane; and
adding the composition comprising the cyanoethyltrimethoxysilane to a polyorganosiloxane sealant composition.

14. The method of claim 13, where the polyorganosiloxane sealant composition comprises an alkoxy-functional polyorganosiloxane.

15. The method of claim 13, where the polyorganosiloxane sealant composition comprises an acyloxy-functional polyorganosiloxane.

16. The process of claim 5, where step 2) is performed for a time of at least 1 hour and up to 16 hours.
